(19) United States
(12) Patent Application Publication
(10) Pub. No.: US 2026/0138287 A1
(43) Pub. Date: May 21, 2026

(54) FINGER, ROBOT HAND, AND ROBOT

(71) Applicant: Zhejiang Qiangnao Technology Co., Ltd., Hangzhou (CN)

(72) Inventors: Bicheng HAN, Hangzhou (CN); Wenguang WANG, Hangzhou (CN); Disi A, Hangzhou (CN); Yiqian GAO, Hangzhou (CN); Zhan LU, Hangzhou (CN); Junhan LI, Hangzhou (CN)

(73) Assignee: Zhejiang Qiangnao Technology Co., Ltd., Hangzhou (CN)

(21) Appl. No.: 19/358,883

(22) Filed: Oct. 15, 2025

(30) Foreign Application Priority Data
Nov. 15, 2024 (CN) 202411631634.7

(51) Int. Cl. B25J 15/00; B25J 18/02

(52) U.S. Cl. CPC B25J 15/0009; B25J 18/025

(57) ABSTRACT

A finger, a robot hand, and a robot are provided. The finger includes a support, a telescopic finger portion rotatably connected to the support, a rotatable finger portion rotatably connected to the telescopic finger portion, and a first driver configured to drive the telescopic finger portion to extend and collapse, so that the telescopic finger portion rotates relative to the support and drives the rotatable finger portion to rotate relative to the telescopic finger portion. When the first driver drives the telescopic finger portion to extend and collapse, the rotational torque of the telescopic finger portion, the rotational torque of the rotatable finger portion, and the extension and collapse torque of the telescopic finger portion can be formed, thereby generating a more reliable grasping force and making it easier to grasp object.

### CROSS-REFERENCE TO RELATED APPLICATIONS

The present application claims priority to Chinese Patent Application No. 202411631634.7, filed on Nov. 15, 2024, the content of all of which is incorporated herein by reference.

### TECHNICAL FIELD

The present disclosure relates to the technical field of robots, in particularly to a finger, a robot hand, and a robot.

### BACKGROUND

A robot hand is generally designed to mimic a human hand. A finger of the robot hand has multiple knuckles, and the knuckles are rotatably connected in sequence to achieve the flexion and extension of the finger.

In the prior art, the finger of the robot hand mainly realizes the rotation of the knuckles through a driving structure. For example, the driving structure drives one knuckle to rotate, so as to drive another knuckle to rotate. Rotational torque is mainly formed and the grasping force of the finger is insufficient.

Therefore, the prior art still needs to be improved and developed.

### SUMMARY

In view of the above-mentioned defects of the prior art, the present disclosure provides a finger, a robot hand, and a robot to solve the problem that the finger of the robot hand in the prior art mainly forms the rotational torque and the grasping force of the finger is insufficient.

Technical solutions of the present disclosure to solve technical problems are as follows.

A finger, includes:
a support;
a telescopic finger portion, rotatably connected to the support;
a rotatable finger portion, rotatably connected to the telescopic finger portion; and
a first driver, configured to drive the telescopic finger portion to extend and collapse, so that the telescopic finger portion rotates relative to the support and drives the rotatable finger portion to rotate relative to the telescopic finger portion.

In some embodiments, the telescopic finger portion includes:
an outer housing, rotatably arranged at the support;
an inner housing, rotatably arranged at the support; and
a connector, rotatably arranged at the inner housing;
where the outer housing is rotatably connected to the rotatable finger portion, and the connector is rotatably connected to the rotatable finger portion.

In some embodiments, the outer housing is connected to the rotatable finger portion through a rotation shaft, the first driver is a telescopic driver, and the telescopic driver is connected to the rotation shaft.

In some embodiments, the telescopic driver includes:
a driving member, arranged at the inner housing;
a threaded rod, arranged at an output shaft of the driving member; and
a threaded barrel, threadedly connected to the threaded rod;
where the threaded barrel is connected to the rotation shaft.

In some embodiments, a central axis of the threaded rod intersects with a central axis of the rotation shaft.

In some embodiments, a bottom of the outer housing is rotatably connected to the support; and
a side of the inner housing is rotatably connected to the support.

In some embodiments, the finger further includes:
a base, rotatably connected to the support; and
a second driver, arranged at the base;
where the second driver is configured to drive the support to rotate.

In some embodiments, a rotation direction of the base relative to the support is perpendicular to a rotation direction of the telescopic finger portion relative to the support.

A method for controlling the finger as described in any one of the above, includes:
controlling the first driver to drive the telescopic finger portion to extend and collapse, so that the telescopic finger portion rotates relative to the support and drives the rotatable finger portion to rotate relative to the telescopic finger portion.

In some embodiments, the method further includes:
controlling the second driver to drive the support to rotate relative to the base.

A robot hand, includes the finger as described in any one of the above.

A robot, includes the finger as described in any one of the above, or the robot hand as described above.

Beneficial effects: The first driver drives the telescopic finger portion to extend and collapse, and jointly drives both the telescopic finger portion to rotate relative to the support, and the rotatable finger portion to rotate relative to the telescopic finger portion. The rotation of two knuckles is achieved through one first driver. When the first driver drives the telescopic finger portion to extend and collapse, a rotational torque of the telescopic finger portion, a rotational torque of the rotatable finger portion, and an extension and collapse torque of the telescopic finger portion can be formed, thereby generating a more reliable grasping force and making it easier to grasp objects.

### BRIEF DESCRIPTION OF DRAWINGS

FIG. 1 is a schematic diagram of a structure of a finger in the embodiments of the present disclosure.

FIG. 2 is a schematic diagram of a structure of the finger after removing an outer housing in the embodiments of the present disclosure.

FIG. 3 is a cross-sectional view of the finger in the embodiments of the present disclosure.

FIG. 4 is a schematic diagram of a structure of the finger after removing a rotatable finger portion in the embodiments of the present disclosure.

FIG. 5 is a schematic diagram of a structure of an inner housing in the embodiments of the present disclosure.

FIG. 6 is a schematic diagram of a structure of the outer housing in the embodiments of the present disclosure.

### DETAILED DESCRIPTION OF EMBODIMENTS

In order to make the purposes, technical solutions, and advantages of the present disclosure clearer and more specific, the present disclosure is further described in detail below with reference to the accompanying drawings and embodiments. It should be understood that the embodiments described herein are only used to explain the present disclosure and are not used to limit the present disclosure.

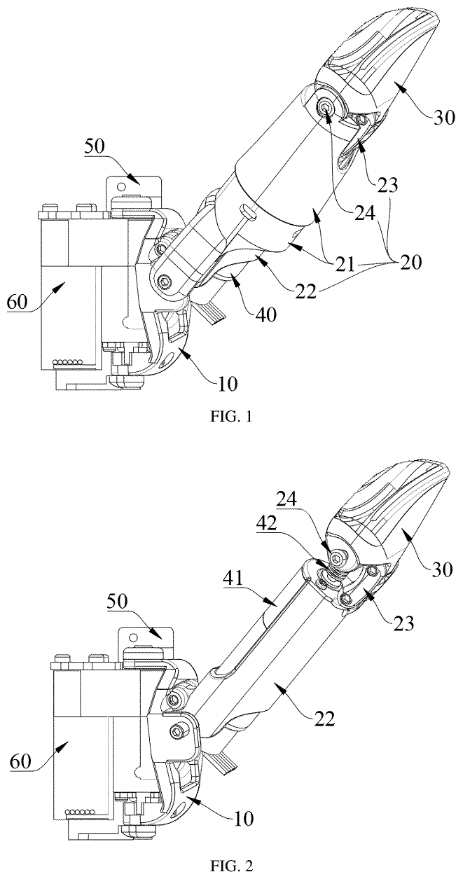

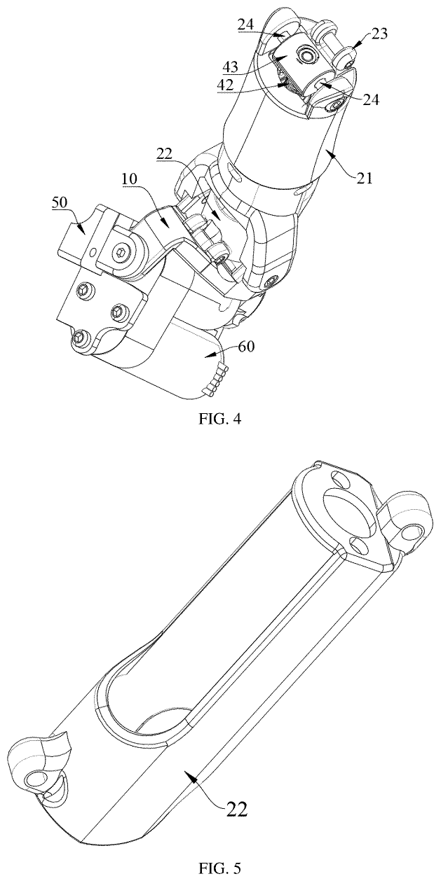

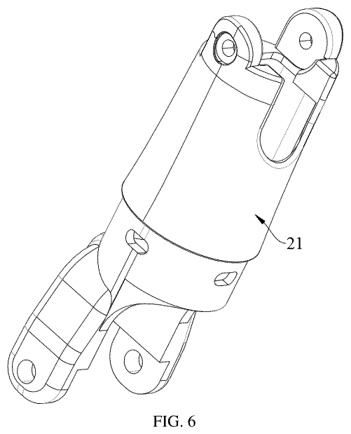

Referring to FIGS. 1 to 6 simultaneously, the present disclosure provides some embodiments of a finger.

As shown in FIG. 1, the finger of the present disclosure includes:
a support 10;
a telescopic finger portion 20, rotatably connected to the support 10;
a rotatable finger portion 30, rotatably connected to the telescopic finger portion 20; and
a first driver 40, configured to drive the telescopic finger portion 20 to extend and collapse, so that the telescopic finger portion 20 rotates relative to the support 10 and drives the rotatable finger portion 30 to rotate relative to the telescopic finger portion 20.

The telescopic finger portion 20 and the rotatable finger portion 30 are both knuckles of the finger. The telescopic finger portion 20 has a function of extension and collapse, and the rotatable finger portion 30 rotates relative to the telescopic finger portion 20. When the telescopic finger portion 20 extends and collapses, the telescopic finger portion 20 rotates relative to the support 10, and drives the rotatable finger portion 30 to rotate relative to the telescopic finger portion 20, so as to achieve the overall flexion of the finger. The first driver 40 drives the telescopic finger portion 20 to extend and collapse, and jointly drives both the telescopic finger portion 20 to rotate relative to the support 10, and the rotatable finger portion 30 to rotate relative to the telescopic finger portion 20. The rotation of the two knuckles is achieved through one first driver 40. When the first driver 40 drives the telescopic finger portion to extend and collapse, the rotational torque of the telescopic finger portion 20, the rotational torque of the rotatable finger portion 30, and the extension and collapse torque of the telescopic finger portion 20 can be formed, thereby generating a more reliable grasping force, making it easier to grasp objects.

In an implementation of the embodiments of the present disclosure, as shown in FIGS. 1 to 3, FIG. 5, and FIG. 6, the telescopic finger portion 20 includes:
an outer housing 21, rotatably arranged at the support 10;
an inner housing 22, rotatably arranged at the support 10; and
a connector 23, rotatably arranged at the inner housing 22.

The outer housing 21 is rotatably connected to the rotatable finger portion 30, and the connector 23 is rotatably connected to the rotatable finger portion 30.

The outer housing 21 is sleeved outside the inner housing 22, and the inner housing 22 can move inside the outer housing 21. Both the inner housing 22 and the outer housing 21 are rotatably connected to the support 10, the outer housing 21 is rotatably connected to the rotatable finger portion 30, and the inner housing 22 is rotatably connected to the rotatable finger portion 30 through the connector 23. The connection position between the outer housing 21 and the support 10 is different from the connection position between the inner housing 22 and the support 10, so that the position of a rotation center axis of the outer housing 21 rotating relative to the support 10 is different from the position of a rotation center axis of the inner housing 22 rotating relative to the support 10. When the outer housing 21 rotates relative to the support 10, the inner housing 22 also rotates relative to the support 10, and the inner housing 22 moves relative to the outer housing 21.

The position of a rotation center axis of the rotatable finger portion 30 rotating relative to the outer housing 21 is different from the position of a rotation center axis of the rotatable finger portion 30 rotating relative to the connector 23. When the inner housing 22 moves relative to the outer housing 21, the inner housing 22 pushes the rotatable finger portion 30 to rotate relative to the outer housing 21 through the connector 23, and the rotatable finger portion 30 also rotates relative to the connector 23. The connection position between the outer housing 21 and the support 10 and the connection position between the outer housing 21 and the rotatable finger portion 30 both correspond to a central axis of the outer housing 21. The connection position between the inner housing 22 and the support 10 and the connector 23 are respectively located on two sides of the central axis of the outer housing 21 (or the inner housing 22).

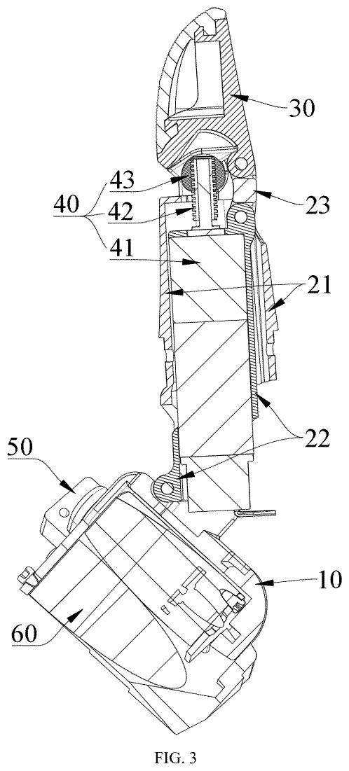

In an implementation of the embodiments of the present disclosure, as shown in FIG. 1, FIG. 2, and FIG. 4, the outer housing 21 is connected to the rotatable finger portion 30 through a rotation shaft 24, the first driver 40 is a telescopic driver, and the telescopic driver is connected to the rotation shaft 24.

The outer housing 21 is arranged with the rotation shaft 24, the rotatable finger portion 30 is rotatably connected to the rotation shaft 24, and the outer housing 21 and the rotatable finger portion 30 are rotatably connected through the rotation shaft 24. The telescopic driver is rotatably connected to the rotation shaft 24, and a spacing between the rotation shaft 24 and the inner housing 22 is changed by the extension and collapse of the telescopic driver. The inner housing 22 pushes the rotatable finger portion 30 through the connector 23.

In an implementation of the embodiments of the present disclosure, as shown in FIGS. 2 to 4, the telescopic driver includes:
a driving member 41, arranged at the inner housing 22;
a threaded rod 42, arranged at an output shaft of the driving member 41; and
a threaded barrel 43, threadedly connected to the threaded rod 42.

The threaded barrel 43 is connected to the rotation shaft 24.

The driving member 41 is arranged at the inner housing 22, and the threaded barrel 43 is connected to the outer housing 21 through the rotation shaft 24. The driving member 41 is configured to drive the threaded rod 42 to rotate. The threaded barrel 43 is threadedly connected to the threaded rod 42. The threaded rod 42 and the threaded barrel 43 convert the rotation of the driving member 41 into the relative movement of the threaded barrel 43 and the driving member 41, thereby realizing the relative movement of the inner housing 22 and the outer housing 21.

In an implementation of the embodiments of the present disclosure, as shown in FIG. 2 and FIG. 3, a central axis of the threaded rod 42 intersects with a central axis of the rotation shaft 24.

The central axis of the threaded rod 42 is perpendicular to the central axis of the rotation shaft 24. When the threaded rod 42 rotates, the threaded barrel 43 moves along the central axis of the threaded rod 42. The central axis of the threaded rod 42 intersects with the central axis of the rotation shaft 24, and the driving member 41 is located at the position of a central axis of the inner housing 22, so that the overall structure is more uniform.

In an implementation of the embodiments of the present disclosure, as shown in FIGS. 1 to 4, a bottom of the outer housing 21 is rotatably connected to the support 10, and a side of the inner housing 22 is rotatably connected to the support 10.

The connection position between the outer housing 21 and the support 10 is located at the bottom of the outer housing 21, and the connection position between the inner housing 22 and the support 10 is located at the side of the inner housing 22. The two connection positions are different, and the rotation conditions of the two connection positions relative to the support 10 are also different, so that the inner housing 22 and the outer housing 21 can move relative to each other.

In an implementation of the embodiments of the present disclosure, as shown in FIGS. 1 to 4, the finger further includes:
a base 50, rotatably connected to the support 10; and
a second driver 60, arranged at the base 50.

The second driver 60 is configured to drive the support 10 to rotate.

The support 10 is arranged at the base 50, and the second driver 60 drives the support 10 to rotate, thereby driving the telescopic finger portion 20 and the rotatable finger portion 30 to rotate together. The second driver 60 is arranged at the base 50 and connected to the support 10.

In an implementation of the embodiments of the present disclosure, as shown in FIG. 1 and FIG. 2, a rotation direction of the base 50 relative to the support 10 is perpendicular to a rotation direction of the telescopic finger portion 20 relative to the support 10.

The rotation direction of the base 50 relative to the support 10 is a first direction, and the rotation direction of the telescopic finger portion 20 relative to the support 10 is a second direction. The first direction and the second direction are different, for example, the first direction is perpendicular to the second direction.

Based on the finger described in any one of the above embodiments, the present disclosure further provides an embodiment of a method for controlling the finger.

The method for controlling the finger of the present disclosure includes:
Step S100: controlling the first driver to drive the telescopic finger portion to extend and collapse, so that the telescopic finger portion rotates relative to the support and drives the rotatable finger portion to rotate relative to the telescopic finger portion.

The first driver is controlled to drive the telescopic finger portion to extend and collapse, so that the telescopic finger portion rotates relative to the support and the rotatable finger portion rotates relative to the telescopic finger portion, and the finger is in a flexed state or an extended state. When flexing the finger, the support and the rotatable finger portion both rotate toward the telescopic finger portion with the telescopic finger portion as a reference. When extending the finger, the support and the rotatable finger portion both rotate away from the telescopic finger portion with the telescopic finger portion as a reference.

Step S100 includes following steps:
Step S110: receiving a flexion instruction, and controlling the first driver to rotate in a forward direction to shorten the telescopic finger portion; and
Step S120: receiving an extension instruction, and controlling the first driver to rotate in a reverse direction to lengthen the telescopic finger portion.

When flexing the finger, the first driver is controlled to rotate in the forward direction according to the flexion instruction, so that the telescopic finger portion is shortened, the telescopic finger portion and the rotatable finger portion are both close to the support, and the finger is flexed. When extending the finger, the first driver is controlled to rotate in the reverse direction according to the extension instruction, so that the telescopic finger portion is lengthened, the telescopic finger portion and the rotatable finger portion are both away from the support, and the finger is extended.

The control method further includes:
Step S200: controlling the second driver to drive the support to rotate relative to the base.

The orientation of the finger is changed by controlling the second driver to drive the support to rotate relative to the base. Step S100 and step S200 can be performed separately or simultaneously. With the cooperation of the two steps, the finger can form a variety of different postures.

Based on the finger described in any one of the above embodiments, the present disclosure further provides an embodiment of a robot hand.

The robot hand of the present disclosure includes the finger as described in any one of the above embodiments.

Based on the finger or robot hand described in any one of the above embodiments, the present disclosure further provides an embodiment of a robot.

The robot of the present disclosure includes the finger as described in any one of the above embodiments, or the robot hand as described in any one of the above embodiments.

It should be understood that the application of the present disclosure is not limited to the above examples. For ordinary skilled in the art, improvements or changes can be made based on the above description. All these improvements and changes should fall within the protection scope of the claims attached to the present disclosure.

What is claimed is:

1. A finger comprising:
a support;
a telescopic finger portion rotatably connected to the support;
a rotatable finger portion rotatably connected to the telescopic finger portion; and
a first driver configured to drive the telescopic finger portion to extend and collapse, so that the telescopic finger portion rotates relative to the support and drives the rotatable finger portion to rotate relative to the telescopic finger portion;
wherein the telescopic finger portion comprises:
an outer housing rotatably arranged at the support;
an inner housing rotatably arranged at the support; and
a connector rotatably arranged at the inner housing;
wherein the outer housing is rotatably connected to the rotatable finger portion;
the connector is rotatably connected to the rotatable finger portion;
the outer housing is connected to the rotatable finger portion through a rotation shaft;
the first driver is a telescopic driver, the telescopic driver is connected to the rotation shaft, a spacing between the rotation shaft and the inner housing is changed by extension and collapse of the telescopic driver; and
a position of a rotation center axis of the outer housing rotating relative to the support is different from a position of a rotation center axis of the inner housing rotating relative to the support.

2. The finger according to claim 1, wherein the telescopic driver comprises:
a driving member arranged at the inner housing;
a threaded rod arranged at an output shaft of the driving member; and
a threaded barrel threadedly connected to the threaded rod;
wherein the threaded barrel is connected to the rotation shaft.

3. The finger according to claim 2, wherein a central axis of the threaded rod intersects with a central axis of the rotation shaft.

4. The finger according to claim 1, wherein a bottom of the outer housing is rotatably connected to the support, and a side of the inner housing is rotatably connected to the support.

5. The finger according to claim 1, further comprising:
a base rotatably connected to the support; and
a second driver arranged at the base;
wherein the second driver is configured to drive the support to rotate.

6. The finger according to claim 5, wherein a rotation direction of the base relative to the support is perpendicular to a rotation direction of the telescopic finger portion relative to the support.

7. A robot hand comprising:
a finger, and the finger comprises:
a support;
a telescopic finger portion rotatably connected to the support;
a rotatable finger portion rotatably connected to the telescopic finger portion; and
a first driver configured to drive the telescopic finger portion to extend and collapse, so that the telescopic finger portion rotates relative to the support and drives the rotatable finger portion to rotate relative to the telescopic finger portion;
wherein the telescopic finger portion comprises:
an outer housing rotatably arranged at the support;
an inner housing rotatably arranged at the support; and
a connector rotatably arranged at the inner housing;
wherein the outer housing is rotatably connected to the rotatable finger portion;
the connector is rotatably connected to the rotatable finger portion;
the outer housing is connected to the rotatable finger portion through a rotation shaft;
the first driver is a telescopic driver, the telescopic driver is connected to the rotation shaft, a spacing between the rotation shaft and the inner housing is changed by extension and collapse of the telescopic driver; and
a position of a rotation center axis of the outer housing rotating relative to the support is different from a position of a rotation center axis of the inner housing rotating relative to the support.

8. The robot hand according to claim 7, wherein the telescopic driver comprises:
a driving member arranged at the inner housing;
a threaded rod arranged at an output shaft of the driving member; and
a threaded barrel threadedly connected to the threaded rod;
wherein the threaded barrel is connected to the rotation shaft.

9. The robot hand according to claim 8, wherein a central axis of the threaded rod intersects with a central axis of the rotation shaft.

10. The robot hand according to claim 7, wherein a bottom of the outer housing is rotatably connected to the support, and a side of the inner housing is rotatably connected to the support.

11. The robot hand according to claim 7, wherein the finger further comprises:
a base rotatably connected to the support; and
a second driver arranged at the base;
wherein the second driver is configured to drive the support to rotate.

12. The robot hand according to claim 11, wherein a rotation direction of the base relative to the support is perpendicular to a rotation direction of the telescopic finger portion relative to the support.

13. A robot comprising:
a finger, and the finger comprises:
a support;
a telescopic finger portion rotatably connected to the support;
a rotatable finger portion rotatably connected to the telescopic finger portion; and
a first driver configured to drive the telescopic finger portion to extend and collapse, so that the telescopic finger portion rotates relative to the support and drives the rotatable finger portion to rotate relative to the telescopic finger portion;
wherein the telescopic finger portion comprises:
an outer housing rotatably arranged at the support;
an inner housing rotatably arranged at the support; and
a connector rotatably arranged at the inner housing;
wherein the outer housing is rotatably connected to the rotatable finger portion;
the connector is rotatably connected to the rotatable finger portion;
the outer housing is connected to the rotatable finger portion through a rotation shaft;
the first driver is a telescopic driver, the telescopic driver is connected to the rotation shaft, a spacing between the rotation shaft and the inner housing is changed by extension and collapse of the telescopic driver; and
a position of a rotation center axis of the outer housing rotating relative to the support is different from a position of a rotation center axis of the inner housing rotating relative to the support.

14. The robot according to claim 13, wherein the telescopic driver comprises:
a driving member arranged at the inner housing;
a threaded rod arranged at an output shaft of the driving member; and
a threaded barrel threadedly connected to the threaded rod;
wherein the threaded barrel is connected to the rotation shaft.

15. The robot according to claim 14, wherein a central axis of the threaded rod intersects with a central axis of the rotation shaft.

16. The robot according to claim 13, wherein a bottom of the outer housing is rotatably connected to the support, and a side of the inner housing is rotatably connected to the support.

17. The robot according to claim 13, wherein the finger further comprises:
a base rotatably connected to the support; and
a second driver arranged at the base;
wherein the second driver is configured to drive the support to rotate.

18. The robot according to claim 17, wherein a rotation direction of the base relative to the support is perpendicular to a rotation direction of the telescopic finger portion relative to the support.
